(19) United States
(12) Patent Application Publication
(10) Pub. No.: US 2020/0159481 A1
(43) Pub. Date: May 21, 2020

(54) METHOD FOR CONTROLLING DISPLAY OF VEHICLE AND ELECTRONIC DEVICE THEREFOR

(71) Applicant: Samsung Electronics Co., Ltd., Gyeonggi-do (KR)

(72) Inventors: Juyeon YOU, Gyeonggi-do (KR); Dohyoung Kim, Gyeonggi-do (KR); Yongjun Lim, Gyeonggi-do (KR); Kyusung Kim, Gyeonggi-do (KR); Sungkwon Kim, Gyeonggi-do (KR); Yeonee Choi, Gyeonggi-do (KR); Jinyoung Choi, Gyeonggi-do (KR)

(21) Appl. No.: 16/686,765

(22) Filed: Nov. 18, 2019

(30) Foreign Application Priority Data
Nov. 16, 2018 (KR) 10-2018-0141974

(51) Int. Cl. G06F 3/14; H04W 4/48; H04W 48/08; H04W 4/02; B60K 35/00

(52) U.S. Cl. CPC G06F 3/1423; B60K 2370/566; H04W 48/08; H04W 4/023; B60K 35/00; B60K 2370/1534; B60K 2370/182; B60K 2370/52; B60K 2370/164; B60K 2370/166; B60K 2370/167; B60K 2370/592; B60K 2370/5899; B60K 2370/5905; B60K 2370/5911; B60K 2370/563; H04W 4/48

(57) ABSTRACT

Disclosed is a method for controlling a display of a vehicle and an electronic device therefor, the method including acquiring display configuration information related to multiple displays in a vehicle, identifying an access right to access a target display which is at least two of the multiple displays, based on the display configuration information, acquiring first source information, generating second source information to be displayed on the target display, from the first source information based on the access right, and controlling to transmit the second source information to the target display.

### CROSS-REFERENCE TO RELATED APPLICATION(S)

This application is based on and claims priority under 35 U.S.C. § 119 to Korean Patent Application No. 10-2018-0141974, filed on Nov. 16, 2018, in the Korean Intellectual Property Office, the disclosure of which is incorporated by reference herein in its entirety.

### BACKGROUND

### 1. Field

The disclosure relates generally to an electronic device, and more particularly, to a method for controlling a display of a vehicle and an electronic device therefor.

### 2. Description of Related Art

Various apparatuses, such as a navigation apparatus, an in-vehicle infotainment (IVI) apparatus, or an on-board diagnostics (OBD) apparatus, may be installed in a vehicle in order to control the vehicle, deliver information, or provide entertainment. Such apparatuses may include a display constituting a screen or may operate in association with an external display.

Various technologies allowing the use of an electronic device, such as a smart phone, which is frequently used and is user-friendly in a vehicle environment according to a user's need, have been developed.

An electronic device may be connected to an external electronic device, such as a monitor or a television, through a docking station. The electronic device may provide various functions to a user through the connected external electronic device. A screen of a smart phone may be mirrored to a monitor having a screen of a size larger than that of the screen of the smart phone. In a structure in which an electronic device is simply connected to one display so as to perform mirroring, a screen of the electronic device is displayed without any change on the one display through mirroring. Therefore, only one particular user can use the structure, which is limiting to users.

When an electronic device is used in a vehicle, there is a need in the art to appropriately reflect a vehicle environment, such as a possibility that a driver and a passenger will ride in a vehicle, a difference in position between the driver and the passenger, and a need to eliminate the risk of distracting the driver while driving, which differs from an ordinary use environment of an electronic device.

There is also a need in the art, in view of the foregoing, to increase the usability of the electronic device by extending a use range of the electronic device to multiple users in the vehicle.

There is also a need in the art for an electronic device that may apply different use ranges to displays in consideration of respective positions, such as a driver seat, a passenger seat, and a rear seat in the vehicle, for better user convenience.

### SUMMARY

Aspects of the disclosure are to address at least the above-mentioned problems and/or disadvantages and to provide at least the advantages described below. Accordingly, an aspect of the disclosure is to provide a method for controlling a display of a vehicle and an electronic device therefor, which, when the electronic device is used in the vehicle, can appropriately reflect a vehicle environment which differs from an ordinary use environment of the electronic device.

Another aspect of the disclosure is to provide a method for controlling a display of a vehicle and an electronic device therefor, which can increase the usability of the electronic device by extending a use range of the electronic device to multiple users in the vehicle.

Another aspect of the disclosure is to provide a method for controlling a display of a vehicle and an electronic device therefor, which can apply different use ranges to displays in consideration of respective positions, such as a driver seat, a passenger seat, and a rear seat, in the vehicle.

In accordance with an aspect of the disclosure, an electronic device includes a communication circuit, a memory, and a processor configured to be operatively connected to the communication circuit and the memory, wherein the memory stores instructions that, when executed, cause the processor to acquire display configuration information related to multiple displays in a vehicle, identify an access right to access a target display which is at least two of the multiple displays, based on the display configuration information, acquire first source information, generate second source information to be displayed on the target display, from the first source information, based on the access right, and transmit the second source information to the target display through the communication circuit.

In accordance with another aspect of the disclosure, a method for controlling a display of a vehicle includes acquiring display configuration information related to multiple displays in a vehicle, identifying an access right to access a target display which is at least two of the multiple displays, based on the display configuration information, acquiring first source information, generating second source information to be displayed on the target display, from the first source information based on the access right, and controlling to transmit the second source information to the target display.

In accordance with another aspect of the disclosure, a vehicle includes at least one display in the vehicle configured to be capable of displaying an image, and an electronic device configured to electrically control the vehicle, wherein the electronic device is configured to store display configuration information related to the at least one display in the vehicle, identify an access right to access a target display which is at least some of the at least one display, based on the display configuration information, acquire first source information, generate second source information to be displayed on the target display, from the first source information based on the access right, and transmit the second source information to the target display.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a system for controlling a display of a vehicle according to an embodiment;

FIG. 2 illustrates a system for controlling a display of a vehicle according to an embodiment;

FIG. 3 illustrates a configuration of an electronic device according to an embodiment;

FIG. 4 illustrates the concept of control of a vehicle display according to an embodiment;

FIG. 5 is a flowchart illustrating operations of controlling a display of a vehicle according to an embodiment;

FIG. 6 is a signal flow diagram illustrating operations of controlling a display of a vehicle according to an embodiment;

FIG. 7 is a signal flow diagram illustrating operations of controlling a display of a vehicle according to an embodiment;

FIG. 8 illustrates an example of a screen configured to control a display of a vehicle according to an embodiment;

FIG. 9 illustrates an example of a screen configured to control a display of a vehicle according to an embodiment;

FIG. 10 illustrates an example of a screen configured to control a display of a vehicle according to an embodiment;

FIG. 11 illustrates an example of a screen configured to control a display of a vehicle according to an embodiment;

FIG. 12 illustrates an example of a screen configured to control a display of a vehicle according to an embodiment;

FIG. 13 illustrates an example of a screen configured to control a display of a vehicle according to an embodiment;

FIG. 14 illustrates an example of a screen configured to control a display of a vehicle according to an embodiment;

FIG. 15 illustrates an example of a screen configured to control a display of a vehicle according to an embodiment;

FIG. 16 is a table describing examples of user inputs of an electronic device for controlling a display of a vehicle according to an embodiment; and

FIG. 17 illustrates a configuration of an electronic device in a network environment according to an embodiment.

### DETAILED DESCRIPTION

Hereinafter, various embodiments will be described with reference to the accompanying drawings. Descriptions of known functions and/or configurations will be omitted for the sake of clarity and conciseness.

Operations of controlling a display of a vehicle according to embodiments may be performed in an order other than the illustrated order, or some operations may be simultaneously performed, without being limited to the order illustrated in the figures to which these methods pertain. Additional operations may be performed as well as the illustrated operations or some of the illustrated operations may be omitted.

Embodiments disclosed herein and the terms used herein are not intended to limit the technical features disclosed herein to specific embodiments, and should be understood to include various modifications, equivalents, or alternatives to the corresponding embodiments. In describing the drawings, similar reference numerals may be used to refer to similar or related elements. A singular expression may include the corresponding plural expression unless the context clearly indicates otherwise. In the disclosure, the expressions “A or B”, “at least one of A and B”, “at least one of A or B”, “A, B, or C”, “at least one of A, B, and C”, and “at least one of A, B, or C” may be any one of items enumerated together in the corresponding expression or may include all possible combinations thereof. The expression “a first”, “a second”, “the first”, or “the second” may be used simply to distinguish a corresponding component from another and does not limit the elements in another aspect, such as importance or order. When an element, such as first element, is referred to as being “coupled” or “connected” to another element, such as a second element, with or without the term “functionally” or “communicatively”, the first element may be connected wiredly or wirelessly to the second element, or connected to the second element through a third element.

The term “module” as used herein may include a unit implemented in hardware, software, or firmware, and may be used interchangeably with the term “logic”, “logical block”, “component”, “circuit”, and may be an integrated component, or a minimum unit for performing one or more functions or a part thereof. For example, according to an embodiment, a module may be implemented in the form of an application-specific integrated circuit (ASIC).

Embodiments of the disclosure enable appropriate reflection of a vehicle environment which differs from an ordinary use environment of an electronic device. When the electronic device is used in a vehicle, embodiments of the disclosure can increase the usability of an electronic device by extending a use range of the electronic device to multiple users in a vehicle, and enable an electronic device to apply different use ranges to displays in consideration of respective positions, such as a driver seat, a side or passenger seat, and a rear seat in a vehicle.

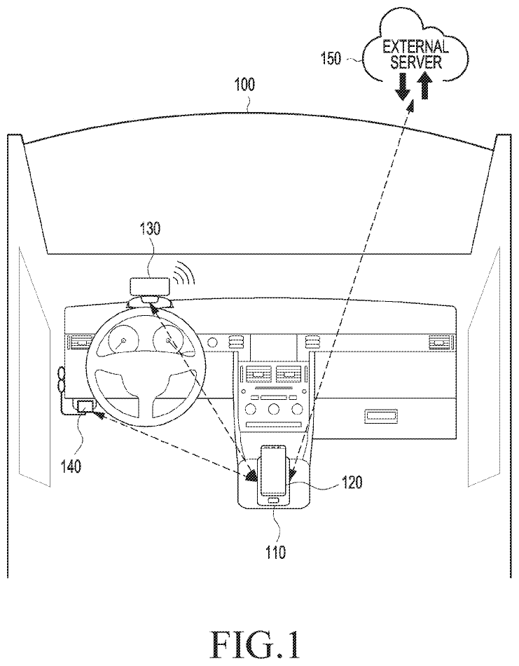

FIG. 1 illustrates a system for controlling a display of a vehicle according to an embodiment.

The system of FIG. 1 may include at least one of a hub unit 110, a first electronic device 120, at least one display 130, and a second electronic device 140. At least one of these devices may be connected to a vehicle network, such as an in-vehicle network (IVN) such as a controller area network (CAN)) or may be included in the vehicle network. The first electronic device 120 may be connected to an external server 150, such as a cloud server.

The hub unit 110 may be a docking station, such as Samsung Dex™. The first electronic device 120 may be a mobile device (e.g., a smartphone) of a user, such as a driver. The second electronic device 140 may be a legacy device, such as an OBD device or an IVI head unit in a vehicle 100.

FIG. 1 illustrates an example of controlling one vehicle display 130, such as a navigation device, but the vehicle display 130 to be controlled may be extended to multiple vehicle displays.

A connection relationship between the devices for control of the vehicle display 130 will be described below by way of example.

The first electronic device, 120 may be a source device which provides source information, such as contents including but not limited to files, images, games, and music, or information on a particular application or an application list, to the vehicle display 130 so as to be capable of sharing its screen with the vehicle display 130.

The display 130 may be a navigation device installed at each position or area, (e.g., a driver seat) in the vehicle 100. The display 130 may be a sync device configured to share a screen of the first electronic device 120 by receiving source information from the first electronic device 120.

The first electronic device 120 may be connected to the display 130 or the second electronic device 140 through the hub unit 110.

The second electronic device 140 may be a legacy device in the vehicle 100. The second electronic device 140 may be an embedded device of the vehicle 100. The second electronic device 140 may be a vehicle control device in a vehicle network. The second electronic device 140 may be embedded in the vehicle 100 so as to identify, store, monitor, diagnose, or control various pieces of unique vehicle information (vehicle-specialized information, such as information on an electrical/electronic operating state of the vehicle, or driving information, such as speed or driving record. The second electronic device 140 may also be an OBD device or an IVI head unit.

The hub unit 110 may be configured to establish a connection or share a screen among electronic devices 120, 130, and 140, may provide at least one of a function as a central control device configured to control the at least one vehicle display 130, a communication function, such as an ultra-high-speed wireless communication function, an interface function for information sharing, a mirror function, or a replication function, and may support various types of connections or may provide a function of extending an interface.

In FIG. 1, the hub unit 110 is illustrated as an example in which the hub unit 110 is configured as a separate stand-alone device, such as a docking station, but may be configured in various types.

The hub unit 110 may be configured as at least one type of device among a separate stand-alone device, a sub-unit embedded in the vehicle 100, such as a wireless charging zone, and a sub-unit included in the first electronic device 120.

The hub unit 110 may be configured as a stand-alone device which is stand-alone in terms of hardware or software. In this example, the hub unit 110 may be configured in the form of a charging pad and may additionally provide a charging function, such as a high-speed wireless charging function, a support function, a detachable/attachable function, and the like. The hub unit 110 may be sold in the form of a stand-alone aftermarket product after the vehicle is initially sold. The first electronic device 120 may be connected to the hub unit 110 in a wired or wireless manner, such as a connection through a connector or Bluetooth® pairing. The vehicle display 130 may be connected to the first electronic device 120 through the hub unit 110 when the first electronic device 120 is connected to the hub unit 110.

As another example, the hub unit 110 may be configured as a sub-unit embedded in the vehicle 100, such as a wireless charging zone in a vehicle. In this example, the hub unit 110 may be embedded in a vehicle in an original equipment manufacturer (OEM) state. A function itself of the hub unit 110 is embedded in the vehicle 100 so as to be pre-connected to the second electronic device 140, and thus connecting a connector for a wired connection, for connection with the display 130 or the second electronic device 140, may be omitted.

As another example, the hub unit 110 may be configured as a sub-unit included in the first electronic device 120. In this example, the hub unit 110 may be implemented as a function within the first electronic device 120. A function of the hub unit 110 may be implemented in the form of software, such as a mirroring application or a docking application. The hub unit 110 may be included in the first electronic device 120, and thus, the first electronic device 120 may be directly connected to the display 130 or the second electronic device 140 without a separate intermediation device or separate connection work.

In the example described with reference to FIG. 1, the hub unit 110 may support a connection or screen sharing between the first electronic device 120, and the vehicle display 130, or between the first electronic device 120 and the second electronic device 140 (e.g., an OBD device).

In order to share a screen of the first electronic device 120 with the vehicle display 130, the user may connect the first electronic device 120 to the hub unit 110. The hub unit 110 may be in a state of being pre-connected to the vehicle display 130 or the second electronic device 140. The user may connect the first electronic device 120 to the hub unit 110 in this state in a wired or wireless manner, and thus, may establish a connection between the first electronic device 120 and the display 130 or between the first electronic device 120 and the second electronic device 140 through the hub unit 110.

The first electronic device 120 may be connected to the vehicle display 130 through the hub unit 110. The first electronic device 120 may also be connected to the second electronic device 140 through the hub unit 110.

The first electronic device 120 may be connected to the external server 150, such as a cloud server). The external server 150 may be included in a network outside the vehicle 100, such as a mobile communication network or the Internet.

As illustrated in FIG. 1, one display 130 may be included in the vehicle 100. The display 130 may correspond to a particular position (or a particular area, e.g., a driver seat) in the vehicle 100.

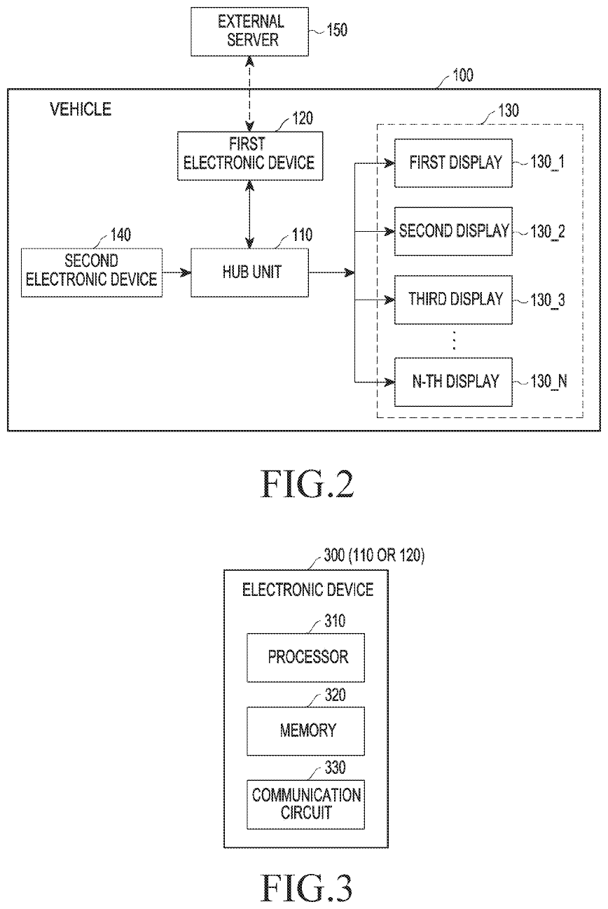

FIG. 2 illustrates a system for controlling a display of a vehicle according to an embodiment.

As illustrated in FIG. 2, at least two displays 130_1 to 130_N may be included in the vehicle 100.

Referring to FIG. 2, the system may include the vehicle 100 and at least one of the electronic devices 110, 120, 130, and 140 within the vehicle. The system may further include the external server 150 outside the vehicle 100.

The vehicle 100 may include at least one display 130, such as a navigation device, within the vehicle 100 capable of displaying an image, and the second electronic device 140 configured to electrically control the vehicle 100. The first electronic device 120 may be a smart phone. The second electronic device 140 may be a legacy device, such as an OBD device or an IVI head unit, embedded in the vehicle 100.

The display 130 may be installed in front of a driver seat and a passenger seat in the vehicle 100. Each display 130 may be configured as a separate stand-alone device including its own processor. As another example, at least two of the displays 130_1 to 130_N may be simple display devices configured to display a screen under the control of a single processor.

The vehicle 100 may include multiple positions (or areas, e.g., a head-up display (HUD)_driver seat, a CLUSTER driver seat, a center information display (CID) first area center, a CID second area_passenger seat, and a rear passenger seat).

The displays 130_1 to 130_N may correspond to the respective positions in the vehicle 100.

The first electronic device 120 may be connected to the vehicle display 130 or the second electronic device 140 in a wired or wireless manner by the user's action or configuration. A connection between the first electronic device 120 and the display 130 or between the first electronic device 120 and the second electronic device 140 may be established through the hub unit 110.

The hub unit 110 may be configured as at least one type of device among a separate stand-alone device, such as a docking station, a sub-unit embedded in the vehicle 100, such as a wireless charging zone in a vehicle, and a sub-unit included in the first electronic device.

The first electronic device 120 may be connected to the external server 150 and may bi-directionally communicate with the external server 150. The external server 150 may be at least one of a data automatic-upgrade server, such as a personal cloud server, a vehicle-to-everything (V2X) server, such as a Samsung cloud server, a vehicle-to-vehicle communication network (V2V) server, a vehicle-to-infrastructure communication network (V2I) server, road infrastructure, such as CCTVs, speed cameras, parking sensors, traffic lights, and traffic information collection sensors), a traffic information center, a social network service (SNS) server, such as a public cloud server, a global positioning system (GPS) server, a moving-image service server, a platform server, and a content provider (CP) server.

One first electronic device 120 may be connected to at least one vehicle display 130 through the hub unit 110, and thus, may share a screen of the first electronic device 120. The first electronic device 120 may provide different pieces of information to the respective vehicle displays 130. Information provided to each of the multiple vehicle displays 130_1 to 130_N may be appropriately controlled based on configuration information, such as a position in a vehicle, of each vehicle display 130. Each vehicle display 130 may be optimally controlled. The usability of an electronic device 300 can be increased by extending a use range of the electronic device 300 to multiple users.

FIG. 3 illustrates a configuration of an electronic device according to an embodiment.

The electronic device 300 of FIG. 3 may be configured to control the vehicle display 130. The electronic device 300 may be configured to establish a connection with the vehicle display 130 or perform screen sharing therewith.

The electronic device 300 of FIG. 3 may correspond to the hub unit 110 or the first electronic device 120 illustrated in FIG. 1 and FIG. 2. The electronic device 300 may be at least one of a separate stand-alone device (e.g., a docking station), at least a part of a device embedded in the vehicle 100 (e.g., a wireless charging zone), or a sub-unit, such as a particular function, an application, a software module, or a hardware unit included in the electronic device 300.

A user-specific or display-specific screen control may be required in a vehicle environment. In examples, a driver and a passenger may ride together in one vehicle, there may be a difference in position between a driver who should concentrate on driving and a passenger who is relatively free, a need may exist to eliminate the risk of distracting the driver while driving, and another need may exist to distinguish between the driver and the passenger in regard to control rights.

The electronic device 300 may serve as a central control device in regard to the vehicle display 130 in the system.

In another embodiment, while serving as a central control device, the electronic device 300 may combine mobile location information with unique vehicle information, such as speed or fuel information, and may cause the vehicle display 130 to display the combined information, such as over-speed information or information on a nearby gas station.

The electronic device 300 may distribute information (or a screen) from one electronic device to the displays 130_1 to 130_N so as to be suitable for a vehicle environment, may share the information with users in the vehicle and may control the information such that the information is shared to match the respective users, such as a driver or a non-driver. The electronic device 300 may control the vehicle displays 130_1 to 130_N such that distinct characteristics, such as a driving situation of the vehicle environment can be reflected.

Referring to FIG. 3, the electronic device 300 may include a processor 310, a memory 320, and a communication circuit 330. The processor 310, the memory 320, and the communication circuit 330 may be operatively or electrically connected to one another.

The processor 310 may acquire display configuration information related to the multiple displays 130_1 to 130_N in the vehicle 100.

The display configuration information may include at least one piece of information among identification information of each display 130 and position information in the vehicle of each display 130. The display configuration information may further include at least one piece of information among whether to allow access to each display 130, an allowable range of access to each display 130, and a vehicle network environment.

The processor 310 may identify an access right to access a target display, which is at least two of the multiple displays 130_1 to 130_N based on the acquired display configuration information.

The processor 310 may acquire first source information. The processor 310 may generate second source information to be displayed on the target display from the first source information based on the access right. The processor 310 may transmit the second source information to the target display through the communication circuit 330.

The electronic device 300 and the target display may share a screen therebetween in various forms.

The electronic device 300 may be coupled to an embedded device, such as an IVI head unit of the vehicle 100 so as to retrieve at least some of control rights from the embedded device, such as in a handshake scheme. The electronic device 300 may distribute source information, such as mobile information of a smart phone, so as to be suitable for the vehicle environment and may provide the distributed source information to the at least one vehicle display 130.

Examples of pieces of mobile information of a smart phone may include basic information, such as information related to a telephone, a messenger, and a schedule, information suitable for use in a driving situation, such as information related to a navigation application, a music application, and a point-of-interest (POI) service application, and information unsuitable for use in a driving situation, such as information related to a game, moving-image, and gallery application. The electronic device 300 may control such that only the basic information or information suitable for use in a driving situation among the pieces of mobile information of the smart phone is distributed to a driver display, such as the first display 130_1.

When source information is provided, if unique vehicle or driving information is necessary, the electronic device 300 may acquire the unique vehicle information from a vehicle network (e.g., a CAN network) or an embedded device (e.g., an OBD device) of the vehicle 100. The electronic device 300 may receive unique vehicle information, may manipulate the unique vehicle information together with mobile information, and may provide the vehicle display 130 with the manipulated information as information in a customized form.

For only a main display, such as the first display 130_1, taking the initiative according to the vehicle environment, the electronic device 300 may enable the main display to serve as a central control device of the system.

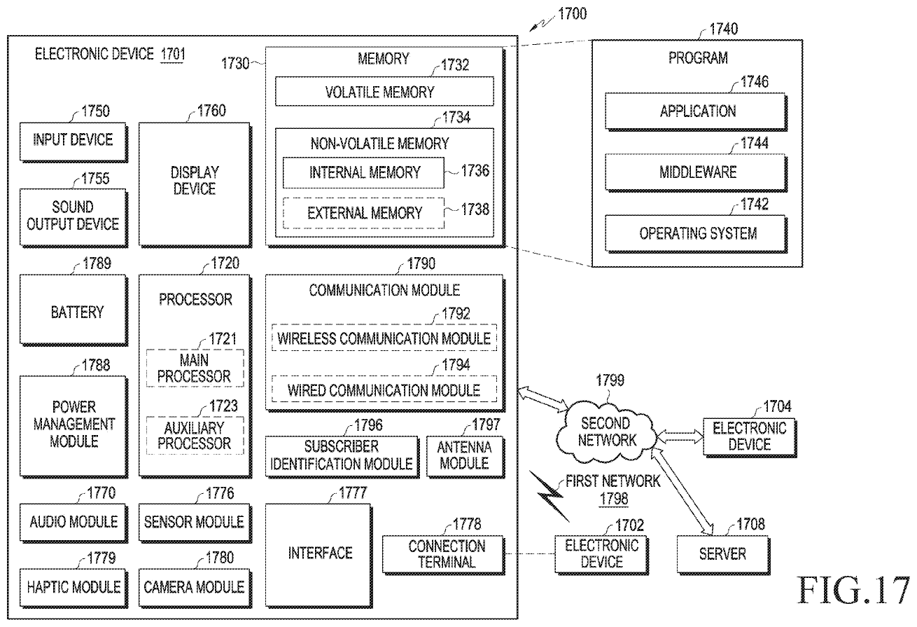

The electronic device 300 may include a part or entirety of an electronic device 1701 described below with reference to FIG. 17. For example, the processor 310 and the memory 320 of the electronic device 300 may correspond to a processor 1720 and a memory 1730 of the electronic device 1701 illustrated in FIG. 17, respectively. The communication circuit 330 of the electronic device 300 may correspond to at least one of a communication module 1790, an interface 1777, or a connection terminal 1778 of the electronic device 1701 illustrated in FIG. 17.

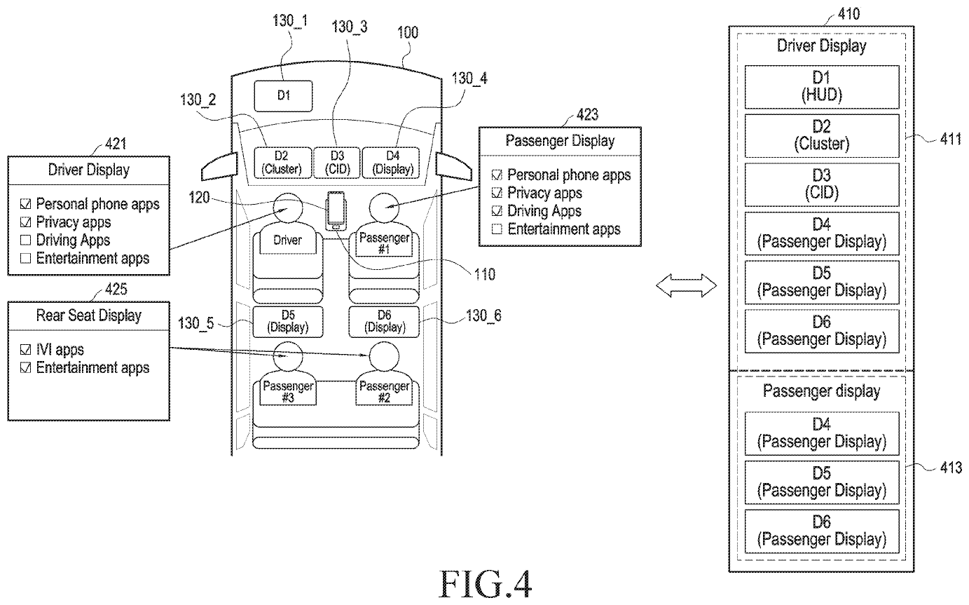

FIG. 4 illustrates the concept of control of a vehicle display according to an embodiment.

Referring to FIG. 4, the vehicle 100 may include the first electronic device 120 and multiple displays 130_1 to 130_N. Various positions a driver seat, a first passenger seat (a side seat, a second passenger seat (a rear right seat), and a third passenger seat (a rear left seat), may be included in the vehicle 100.

The displays 130 may correspond to the respective positions in the vehicle 100. As an example, each display 130 may be assigned identification information, such as a display ID. Each display 130 or the position of each display 130 in the vehicle 100 may be identified (recognized) based on the identification information of each display 130.

Each display 130 may be at least one of a driver display or a passenger display. The driver display and passenger display may include at least one display.

Users, such as a driver, a first passenger, a second passenger, and a third passenger, may ride at the respective positions in the vehicle 100, where the multiple displays 130_1 to 130_N, may correspond to the respective positions. The driver display may correspond to the driver seat. A passenger display may correspond to the side seat or a rear seat.

In the example described with reference to FIG. 4, the first display 130_1, such as D1(HUD), the second display 130_2, such as D2(Cluster), and the third display 130_3, such as D3(CID), among the multiple displays 130_1 to 130_6 may be a driver display located at the driver seat. The fourth display 130_4 (D4), the fifth display 130_5 (D5), and the sixth display 130_6 (D6) among the multiple displays 130_1 to 130_6 may be passenger displays located at the passenger seats.

A user may connect the first electronic device 120 to the multiple displays 130_1 to 130_N. When the user places the first electronic device 120 on the charging pad-type hub unit 110 included in a wireless charging zone embedded in the vehicle 100, the hub unit 110 may detect the first electronic device 120, and thus may establish a connection between the first electronic device 120 and the multiple displays 130_1 to 130_N.

When the first electronic device 120 is connected to the vehicle display 130, the first electronic device 120 and the vehicle display 130 may bi-directionally share information therebetween. In order to control the vehicle display 130, a display access right may be configured or adjusted.

A display access right may be configured in various forms. The hub unit 110 may configure a display-specific access right based on identification information or position information of each display 130. According to the establishment of a connection between the first electronic device 120 and the vehicle display 130, a display access right may be automatically performed.

As another example, the user may identify a vehicle display list on a screen of the first electronic device 120 or a screen of the display 130 of any vehicle, and may designate at least one of the displays 130_1 to 130_N as a driver display. The other non-designated display(s) may be automatically recognized as passenger display(s). In this example, information unnecessary while driving may be excluded and only information suitable for use in a driving situation may be selectively distributed to a driver display, based on pre-configured classification criteria, such as an application type, of source information.

In another example, a display access right may be configured or adjusted by an input made by the user, such as at least one person among a driver, a first passenger, a second passenger, or a third passenger. The user may configure a display access right on a configuration screen of the first electronic device 120 or a configuration screen of the vehicle display 130. According to the need, the user may arbitrarily select whether access to each display can be allowed or an allowable range of access to each display, such as an accessible screen area of an entire screen. When a right to access the driver display is configured, the other displays may be automatically recognized as passenger displays.

Rights to access the respective displays 130 may be differently configured in consideration of a vehicle environment. As an example, it may be very important to control information in a distinct environment of a vehicle. Therefore, mobile information of a smart phone may be selectively provided to the vehicle display 130 so that a driver can use the mobile information of the smart phone even without viewing or controlling the smart phone.

In FIG. 4, a screen 410 may be a configuration screen of the first electronic device 120. Information on the vehicle display 130 may be displayed on the configuration screen.

The configuration screen may include at least one of a driver display area 411 or a passenger display area 413. When a user corresponding to the first electronic device 120 is a driver, the driver display area 411 may be displayed on a configuration screen of the first electronic device 120. When a user corresponding to the first electronic device 120 is a non-driver (a passenger), the passenger display area 413 may be displayed on a configuration screen of the first electronic device 120.

A screen 421 may be a configuration screen of the first display 130_1 which is a driver display. The first display 130_1 located at the driver seat may be configured to allow only display of a first part of source information, such as a personal application and some applications which do not disturb driving.

The source information may be mobile information or combined information of the mobile information and unique vehicle information.

A screen 423 may be a configuration screen of the fourth display 130_4 which is a passenger display. A user may configure the fourth display 130_4, located at the side seat, so as to allow only display of a second part of the source information, such as an application for driving assistance and a personal application.

A screen 425 may be a configuration screen of the fifth display 130_5 or the sixth display 130_6 which is a passenger display. The fifth display 130_5 or the sixth display 130_6 located at the rear seat may be configured to allow only display of a third part, such as a vehicle infotainment application and an entertainment application of the source information.

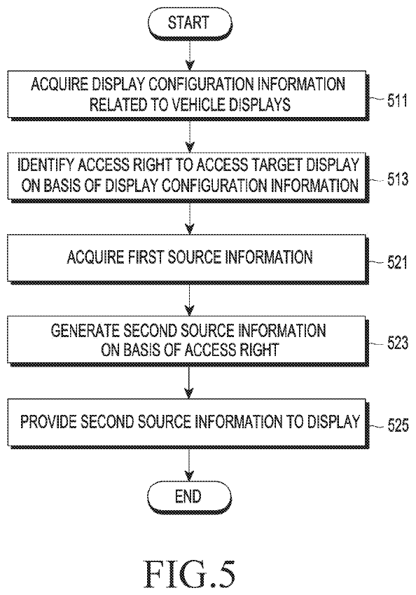

FIG. 5 illustrates operations of controlling a display of a vehicle according to an embodiment. In particular, FIG. 5 illustrates an example of operations of controlling at least one vehicle display 130. The operations illustrated in FIG. 5 may be performed by the electronic device 300 of FIG. 4. The electronic device 300 may correspond to the hub unit 110 or the first electronic device 120 illustrated in FIG. 1 and FIG. 2.

In step 511, the electronic device 300 may acquire display configuration information related to multiple displays 130_1 to 130_N in the vehicle 100.

The display configuration information may include at least one piece of information among identification information of each display 130 and position (a position in a vehicle) information, such as a position identification code, of each display 130.

The display configuration information may further include at least one piece of information among whether to allow access to each display 130, an allowable range of access to each display 130, and a vehicle network environment.

The information on whether to allow access to each display 130 may designate at least one accessible display among the multiple vehicle displays 130_1 to 130_N. The information on an allowable range of access to each display 130 may designate an accessible screen area of each of the multiple vehicle displays 130_1 to 130_N. The information on a vehicle network environment may include information designating a communication scheme, such as a transmission protocol, of each of the multiple vehicle displays 130_1 to 130_N.

The display configuration information may further include a device profile corresponding to a device ID of the first electronic device 120. When there is a history of access by the first electronic device 120 to a vehicle network, the display configuration information may include the device profile corresponding to the device ID of the first electronic device 120.

A right to access each display 130 may be pre-configured by the manufacturer or a user, such as a default value designated by the manufacturer, or a value set by a user. A procedure for configuring (or adjusting) a right to access each display 130 may be additionally performed according to an input by a user, such as a driver or a passenger. The user may configure a display-specific access right on a screen of the electronic device 300 or a screen of the vehicle display 130.

In step 513, the electronic device 300 may identify a right to access a target display which is at least one of the multiple displays based on the display configuration information.

A target display may be a display in an on-state among the multiple displays, a display selected according to designated criteria, such as selecting only a driver display or a non-driver display, a default display, such as a main display located at the driver seat and a display located at the rear right seat); a display designated according to the user's configuration, or one of all the displays included in the vehicle 100.

A right to access at least some of the multiple vehicle displays may be designated by the display configuration information. As an example, in configuring a right to access a target display, such as the display 130_1, when the target display is the first display 130 at the driver seat position is different from when the target display is the second display 130 located at a non-driver seat position.

In step 521, the electronic device 300 may acquire first source information, such as mobile information of a smart phone.

In step 523, the electronic device 300 may generate second source information to be displayed on the target display from the first source information based on the right to access the target display.

In step 525, the electronic device 300 may transmit the generated second source information to the target display.

Second source information may be at least one piece of information among information corresponding to at least a part of first source information; information distributed from the first source information, information extracted from the first source information, information resulting from processing of the first source information; information which shares (mirrors) at least part of the first source information, and information obtained by customizing at least part of the first source information so as to correspond to a target display.

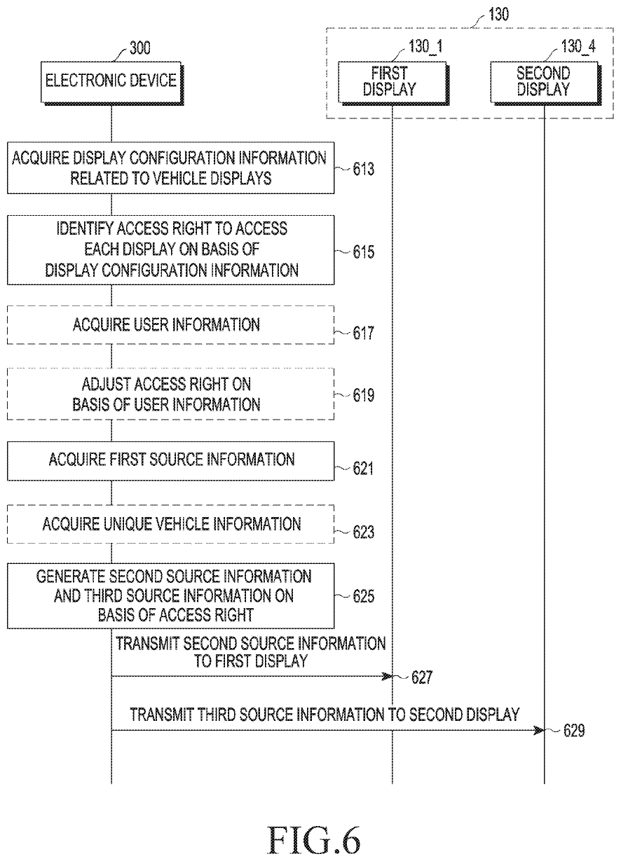

FIG. 6 illustrates operations of controlling a display of a vehicle according to an embodiment.

In particular, FIG. 6 illustrates an example of operations of controlling two vehicle displays 130. The operations illustrated in FIG. 6 may be performed by the electronic device 300 of FIG. 4. The electronic device 300 may correspond to the hub unit 110 or the first electronic device 120 illustrated in FIG. 1 and FIG. 2.

In step 613, the electronic device 300 may acquire display configuration information, such as identification information or position information of each display 130, on multiple vehicle displays.

In step 615, the electronic device 300 may identify a right to access each display 130_1 to 130_N based on the acquired display configuration information. The electronic device 300 may identify a right to access each of a first display, such as the driver display 130_1, and a second display, such as the non-driver display 130_4.

In step 617, the electronic device 300 may further acquire user information of an electronic device 300 on a side which provides first source information, from the relevant electronic device 300.

In step 619, the electronic device 300 may adjust a right to access a target display based on the user information, such as user information indicating that a corresponding user is a driver or indicating that a corresponding user is a non-driver.

The right to access the target display may be adjusted based on a position or a connection position of the electronic device 300. When the electronic device 300 is a smart phone and is wirelessly connected, such as Bluetooth® pairing) to a vehicle network, the right to access the target display may be adjusted based on the position of the electronic device 300. The right to access the target display may be adjusted to correspond to a driver's right based on the position of the electronic device 300 which is the driver seat. As another example, the right to access the target display may be adjusted to correspond to a non-driver's right based on the position of the electronic device 300 which is a non-driver seat.

In step 621, the electronic device 300 may acquire first source information. In step 623, the electronic device 300 may further acquire unique vehicle information, such as vehicle information or driving information). The electronic device 300 may acquire unique vehicle information through an open database connectivity (ODBC) interface of the vehicle 100.

In steps 625, 627, and 629, the electronic device 300 may control screens of the first display 130 and the second display 130 based on the respective rights to access the first display 130 and the second display 130.

In step 625, the electronic device 300 may generate second source information from the first source information based on the right to access the first display 130. The electronic device 300 may generate third source information from the first source information based on the right to access the second display 130.

In step 627, the electronic device 300 may provide the generated second source information to the first display 130 so as to display the second source information on the first display 130.

In step 629, the electronic device 300 may provide the generated third source information to the second display 130 so as to display the third source information on the second display 130.

The second source information or the third source information may further include the unique vehicle information as well as basic information corresponding to the first source information. When driving information includes safety-related information, the electronic device 300 may configure the safety-related information so as to most preferentially display the safety-related information.

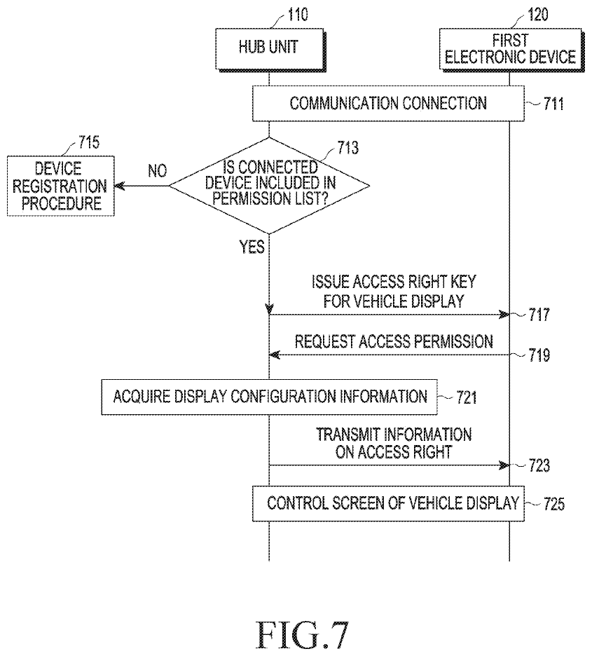

FIG. 7 illustrates operations of controlling a display of a vehicle according to an embodiment.

In particular, FIG. 7 illustrates an example of operations between the hub unit 110 and the first electronic device 120 when the hub unit 110 is configured as a sub-unit which is configured to be embedded in a wireless charging zone of a vehicle, or a stand-alone docking station, separate from the first electronic device 120.

Step 711 may be for a communication connection between the first electronic device 120 and the hub unit 110. In step 711, the hub unit 110 may detect a communication connection with the first electronic device 120.

The hub unit 110 may be in a state of being included in or connected to a vehicle network. The vehicle network may include at least one electronic device, such as at least one of the hub unit 110, the display 130, or the second electronic device 140 of FIG. 1 and FIG. 2, or a processor.

In step 711, a connection, such as Bluetooth® pairing, between the first electronic device 120 and the hub unit 110 may be established. When a user places the first electronic device 120 on a wireless charging zone of the vehicle 100 in which the hub unit 110 is embedded, operation 711 may be performed.

In step 711, the hub unit 110 may scan the first electronic device 120 in the vehicle 100. The first electronic device 120 may access the vehicle network through the hub unit 110. When the first electronic device 120 is not registered in the vehicle network, a procedure for device registration may be additionally performed. A device profile may be stored during device registration. Alternatively, a procedure for updating a device profile of the first electronic device 120 may be additionally performed.

In step 711, the first electronic device 120 may broadcast its own device ID. The hub unit 110 may receive the device ID of the first electronic device 120, and thus, may recognize that the first electronic device 120 has accessed the vehicle network.

In step 713, the hub unit 110 may determine whether the first electronic device 120 is included in a permission list, based on the device ID of the first electronic device 120.

When it is determined in step 713 that the first electronic device 120 is not included in the permission list, in step 715, a device registration procedure for the first electronic device 120 may be performed.

When it is determined in step 713 that the first electronic device 120 is included in the permission list, in step 717, the hub unit 110 may issue an access right key for the vehicle display 130 to the first electronic device 120. The first electronic device 120 may acquire the access right key.

In step 719, the first electronic device 120 may send, to the hub unit 110, a request for permission to access the vehicle display 130. The request may include the access right key.

In step 721, the hub unit 110 may retrieve display configuration information on the vehicle display 130. A display-specific access right may be designated to correspond to the display configuration information.

A display-specific access right may be adjusted based on at least one of a user's configuration, user information of the first electronic device 120, and a position or a connection position of the first electronic device 120.

In step 721, the hub unit 110 may identify an access right to access the vehicle display 130 based on the display configuration information, and may transmit information on the access right to the first electronic device 120.

The display configuration information may include at least one piece of information among identification information of each display 130 and information on a position (a position in a vehicle) of each display 130. The display configuration information may further include at least one of whether to allow access to each display 130, an allowable range of access to each display 130, such as an accessible screen area, information on a vehicle network environment, or a device profile of the first electronic device 120 related to each display 130.

In step 723, the hub unit 110 may identify at least one accessible display 130 among the multiple vehicle displays, or an accessible area of a screen of each display 130, and may notify the first electronic device 120 of the same.

Step 725 may be for controlling a screen of the vehicle display 130. In step 725, the first electronic device 120 may control a screen of the vehicle display 130 based on the access right. As an example, second source information, such as a mirrored moving image, corresponding to source information, such as a moving image reproduced using a particular application, on the first electronic device 120 may be displayed on a partial area of at least one vehicle display 130 or each vehicle display 130.

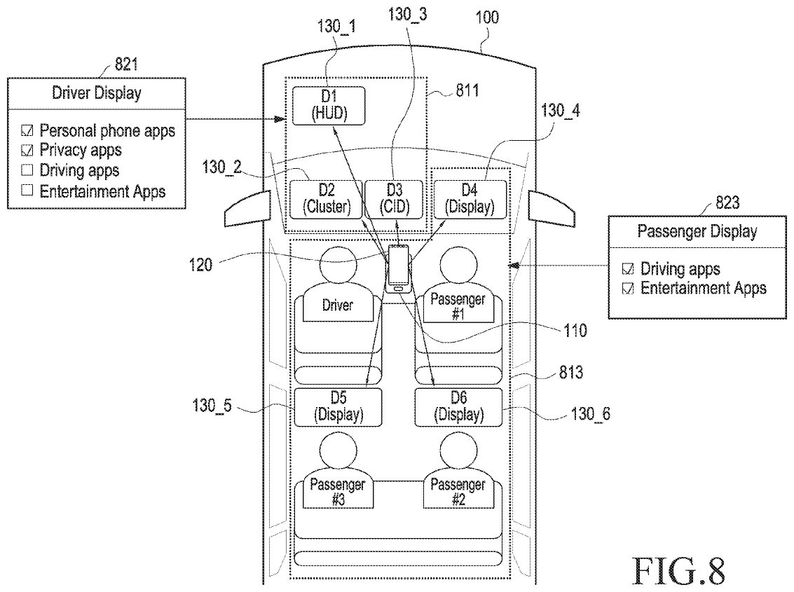

FIG. 8 illustrates an example of a screen configured to control a display of a vehicle according to an embodiment.

In particular, FIG. 8 illustrates a screen example for explaining the distinction between a driver display area 811 and a passenger display area 813.

Referring to FIG. 8, source information of one first electronic device 120 (e.g., a smart phone) may be provided to multiple vehicle displays, such as at least two of the displays 130_1 to 130_6, through the hub unit 110.

At least two of the vehicle displays may be included, as a driver display, in the driver display area 811, and may be included, as a passenger display, in the passenger display area 813.

In an example of FIG. 8, a screen 821 may be a configuration screen of a driver display. A screen 823 may be a configuration screen of a passenger display.

The hub unit 110 may classify and provide pieces of source information, such as information related to application lists included in a smart phone of the first electronic device 120 based on display configuration information, such as a display ID.

A part, such as personal information and security-related application information (personal phone apps), personal privacy-related application information (privacy apps), application information related to the field of IVI and vehicles (driving apps), and entertainment-related application information (entertainment apps), of source information, such as information related to application lists included in a smart phone, of the first electronic device 120 may be provided to a driver display. Another part, such as application information related to the field of IVI and vehicles (driving apps), and entertainment-related application information (entertainment apps)) of source information, such as information on application lists included in a smart phone, of the first electronic device 120 may be provided to a passenger display.

In relation to a driver display, a right to access the driver display may be preferentially granted to a driver. The driver may identify, on a screen 821, an application list supportable for a driver, of source information in which the driver display located at the driver seat can be supported, and may select a part of the range.

In relation to a passenger display, a right to access the passenger display may be selectively granted to a driver. Alternatively, a passenger may configure (or adjust), in person, a right to access a passenger display located at the passenger seat position. The passenger may identify, on a screen 823, a range, such as a supportable application list of source information supportable for the passenger display, and may select a part of the range.

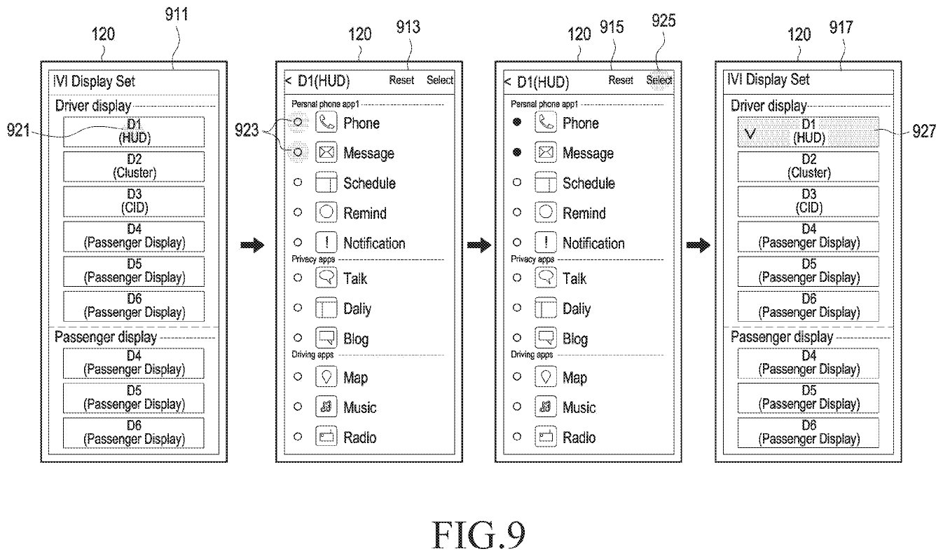

FIG. 9 illustrates an example of a screen configured to control a display of a vehicle according to an embodiment.

In particular, FIG. 9 illustrates an example of a driver display configuration screen of the first electronic device 120.

When the first electronic device 120 is connected to a vehicle network, a basic configuration screen as indicated by reference numeral 911 may be displayed by the first electronic device 120. A vehicle display list may be displayed on the screen 911.

On the screen 911, a first user input 921 for selecting the first display 130_1, which is a driver display, may be detected. According to detection of the first user input 921, the first electronic device 120 may switch from the screen 911 to a screen 913, and thus, may display information items, such as an application list, which can be provided to the driver display.

Among all information items that the first electronic device 120 can provide to the vehicle display 130, information items which can be provided to the driver display may be sorted and provided.

On the screen 913, a second user input 923 for designating information items to be displayed by the first display 130_1 may be detected. On a screen 915, a third user input 925 for completing selection of the information items to be displayed may be detected.

According to detection of the third user input 925, the first electronic device 120 may switch from the screen 915 to a screen 917. On the screen 917, an indicator 927 indicating configuration of the information items to be displayed by the first display 130_1 may be displayed.

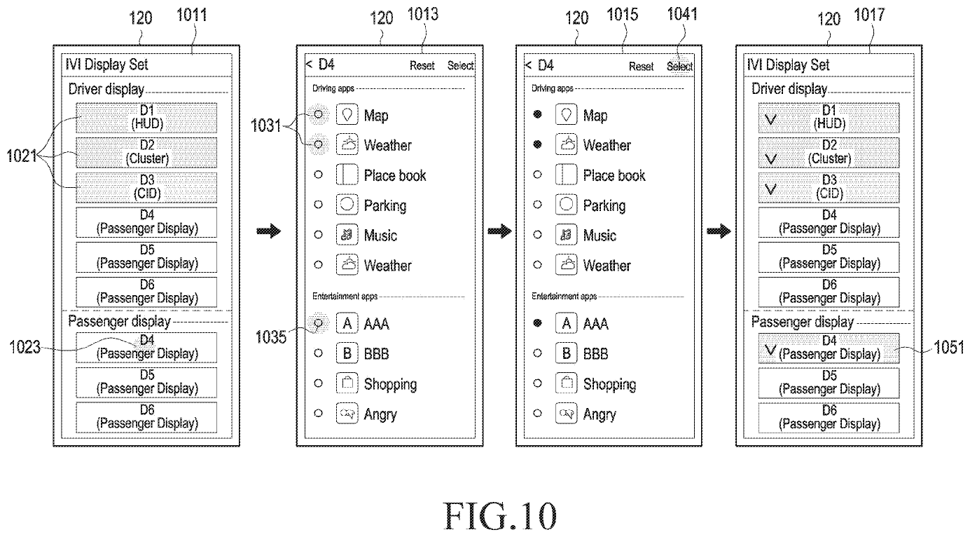

FIG. 10 illustrates an example of a screen configured to control a display of a vehicle according to an embodiment.

In particular, FIG. 10 illustrates an example of a passenger display configuration screen of the first electronic device 120.

After the information items to be displayed on the driver display are configured, a basic configuration screen 1011 may be displayed. On the screen 1011, an indicator, such as indicated by reference numeral 1021, indicating configuration of the information items to be displayed by the driver display may be displayed.

On screen 1011, a first user input 1023 for selecting the fourth display 130_4, which is a passenger display, may be detected. According to detection of the first user input 1023, the first electronic device 120 may switch from screen 1011 to screen 1013, and thus, may display information items, such as an application list, which can be provided to the passenger display.

Among all information items that the first electronic device 120 can provide to the vehicle display 130, information items which can be provided to the passenger display may sorted and provided.

On screen 1013, second user inputs 1031 and 1035 for designating information items to be displayed by the fourth display 130_4 may be detected. On screen 1015, a third user input 1041 for configuring completion of designation of the information items to be displayed may be detected.

According to detection of the third user input 1041, the first electronic device 120 may return to a basic configuration screen 1017, and may display, on the basic configuration screen 1017, an indicator 1051 indicating configuration of the information items to be displayed by the fourth display 130_4.

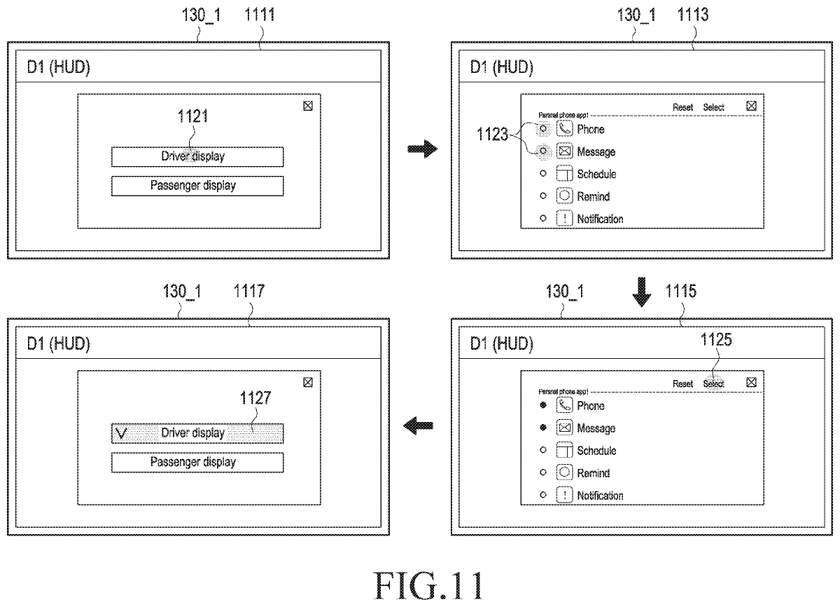

FIG. 11 illustrates an example of a screen configured to control a display of a vehicle according to an embodiment.

In particular, FIG. 11 illustrates an example of a configuration screen of a driver display.

Information items to be displayed on a driver display may be configured not only on a configuration screen of the first electronic device 120, but also on the driver display. The first display 130_1, which is a driver display, may display a screen 1111 (e.g., in a pop-up form). The screen 1111 may be configured to select a driver display or a passenger display.

When a first user input 1121 for selecting a driver display is detected on screen 1111, the first display 130_1 may switch from the screen 1111 to a screen 1113. Screen 1113 may be configured to designate information items to be displayed on a driver display. On screen 1113, a second user input 1123 for designating information items to be displayed on the driver display may be detected. On screen 1115, a third user input 1125 for configuring completion of designation of the information items may be detected.

According to detection of the third user input 1125, the driver display may return to a basic configuration screen 1117. On screen 1117, an indicator 1127 indicating configuration of information items to be displayed on the driver display may be displayed.

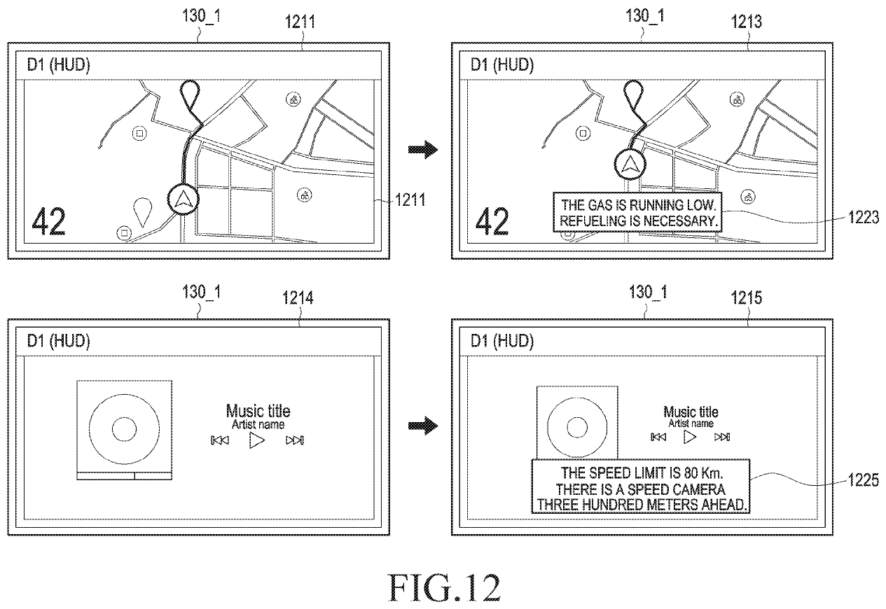

FIG. 12 illustrates an example of a screen configured to control a display of a vehicle according to an embodiment.

In particular, FIG. 12 illustrates an example of a display screen of the first display 130_1 included in a driver display area.

When a third-party application is executed, the first electronic device 120 may receive unique vehicle information, and may provide the first display 130_1 with combined information of information corresponding to the third-party application and the unique vehicle information.

The first display 130_1 may be connected to the first electronic device 120, and thus may display screen 1211 which is an execution screen of a navigation application.

Whether a system abnormality occurs may be detected using the combined information during execution of a navigation application. When it is necessary to notify of the system abnormality, an indicator 1223 indicating a system abnormality may be displayed in the form of a pop-up window on screen 1213. The pop-up window may disappear after a designated period of time, such as N seconds.

The first display 130_1 may be connected to the first electronic device 120, and thus may display screen 1214 which is an execution screen of a music application.

Whether a system abnormality occurs may be detected using the combined information during execution of a music application. When it is necessary to notify of the system abnormality, an indicator 1225 indicating a system abnormality may be displayed in the form of a pop-up window on screen 1215. The pop-up window may disappear after a designated period of time, such as N seconds.

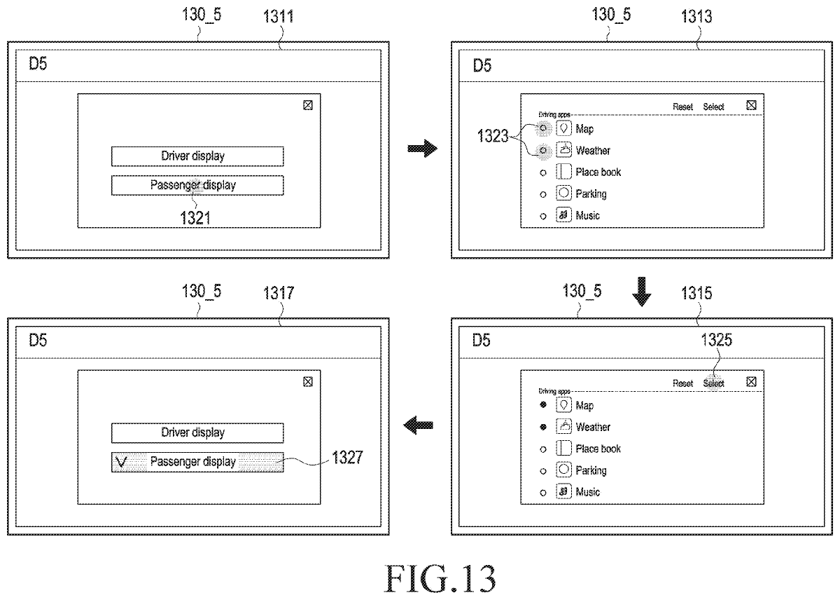

FIG. 13 illustrates an example of a screen configured to control a display of a vehicle according to an embodiment.

In particular, FIG. 13 illustrates an example of a configuration screen of the fifth display 130_5 included in a passenger display area.

Information items to be displayed on a passenger display may be configured not only on a configuration screen of the first electronic device 120, but also on the passenger display.

The fifth display 130_5 which is a passenger display may display a basic configuration screen 1311, such as in a pop-up form.

When a first user input 1321 for selecting a passenger display is detected on screen 1311, the fifth display 130_5 may switch from screen 1311 to screen 1313. Screen 1313 may be configured to designate information items to be displayed on the passenger display. On screen 1313, a second user input 1323 for designating information items to be displayed on the passenger display may be detected. On screen 1315, a third user input 1325 for configuring completion of designation of the information items may be detected. According to detection of the third user input 1325, the fifth display 130_5 may return to a basic configuration screen 1317. On the basic configuration screen 1317, an indicator 1327 indicating configuration of the information items to be displayed on the passenger display may be displayed.

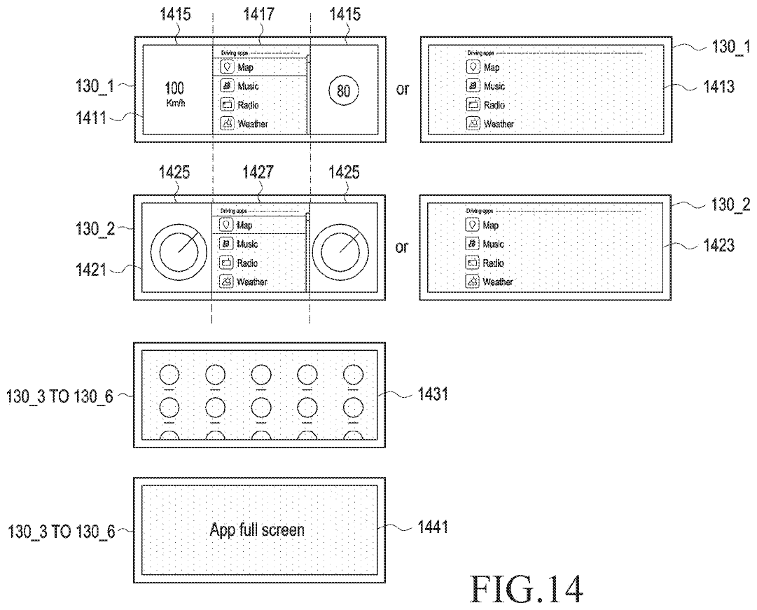

FIG. 14 illustrates an example of a screen configured to control a display of a vehicle according to an embodiment.

In particular, FIG. 14 illustrates an example of a display screen displayed on the vehicle display 130 after configuration of information items to be displayed on the vehicle display 130.

When a screen of the first electronic device 120 is shared with the vehicle display 130, an entire screen of each vehicle display 130 may utilized (screen 1413, screen 1423, screen 1431, and screen 1441), or only a partial area of the entire screen may be utilized, such as an area 1417 of screen 1411 and an area 1427 of screen 1421, based on a display-specific access right.

Screen 1411 or screen 1413 may be a display screen of the first display 130_1. Screen 1411 may include the first area 1417 on which source information is displayed. The first area 1417 may be a mirroring area or an area corresponding to a third-party application. Screen 1411 may include a second area 1415 on which unique vehicle information, such as driving information, is displayed.

Various modifications may be applied to the configuration or arrangement of areas.

Whether each display 130 can be accessed or an accessible area of a screen of each display 130 may be configured based on a display-specific access right.

Screen 1421 or screen 1423 may be a display screen of the second display 130_2.

Screen 1431 or screen 1441 may be a display screen of each of the third display 130_3 to the sixth display 130_6. When a particular application is selected and executed on screen 1431, an execution screen of the selected application may be provided such that the execution screen extends to the full screen, as indicated by reference numeral 1441.

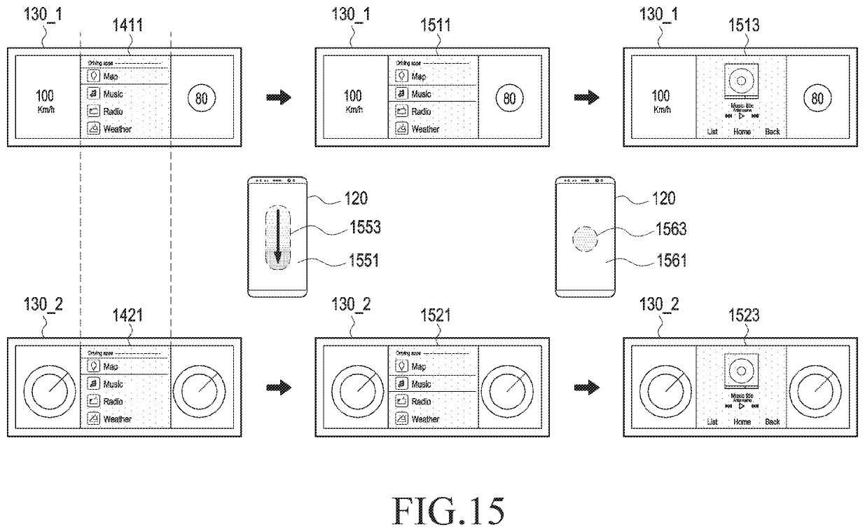

FIG. 15 illustrates an example of a screen configured to control a display of a vehicle according to an embodiment.

In particular, FIG. 15 illustrates an example of a screen when the first electronic device 120 is employed as an input device for the vehicle display 130.

In FIG. 15, screens 1411, 1511, and 1513 are illustrated as an example of screen switching of the first display 130_1 according to a user input.

In FIG. 15, screens 1421, 1521, and 1523 are illustrated as an example of screen switching of the second display 130_2 according to a user input.

When a vehicle display is connected to the first electronic device 120, the first electronic device 120 may be utilized as an input device, such as a touch pad, for the vehicle display. The type of touch input may be detected based on a direction, such as a widthwise or lengthwise direction, in which the first electronic device 120 is placed. A user may control the vehicle display through the user's touch operations 1553 and 1563 performed on respective screens 1551 and 1561 of the first electronic device 120.

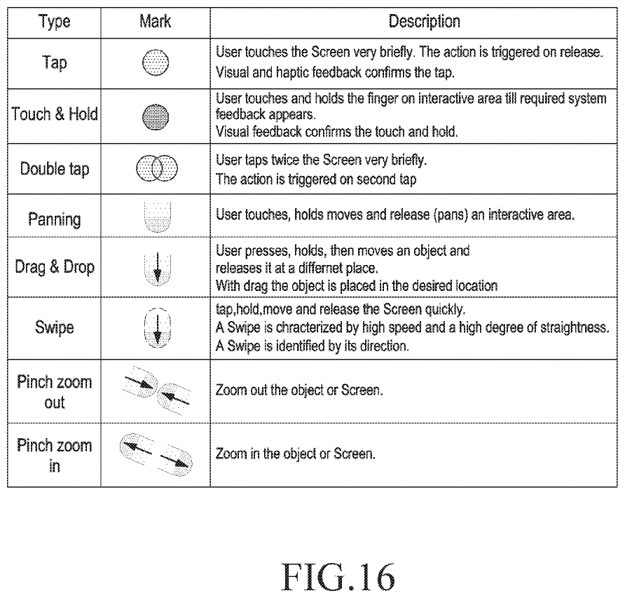

FIG. 16 is a table describing examples of user inputs of an electronic device for controlling a display of a vehicle according to an embodiment.

When the first electronic device 120 is utilized as an input device of the vehicle display 130, the various types of touch inputs illustrated in FIG. 16 may be correspondingly applied. The first electronic device 120 may be configured to be utilized as an input device, for only a function configured to correspond to a driver display (or a driver's right) among the vehicle displays 130.

According to an embodiment, an electronic device includes a communication circuit, a memory, and a processor configured to be operatively connected to the communication circuit and the memory. The memory may store instructions that, when executed, cause the processor to acquire display configuration information related to multiple displays in a vehicle, identify an access right to access a target display which is at least some of the multiple displays, based on the display configuration information, acquire first source information, generate second source information to be displayed on the target display, from the first source information based on the access right, and control to transmit the second source information to the target display through the communication circuit.

The display configuration information may include at least one piece of information among identification information of a display, and position information in the vehicle of the display.

The display configuration information may further include at least one of whether to allow access to the display, an allowable range of access to the display, information on a vehicle network environment, or a device profile of the electronic device related to the display.

The target display may correspond to one of a first display located at a driver seat or a second display located at a non-driver seat. A right to access the first display may be configured differently from a right to access the second display.

The second source information may include at least one piece of information among information corresponding to at least a part of the first source information, information distributed from the first source information; information extracted from the first source information, information resulting from processing of the first source information, information which shares the at least the part of the first source information, and information obtained by customizing the at least the part of the first source information so as to correspond to the target display.

The second source information may further include unique vehicle information.

When the unique vehicle information includes safety-related information, the safety-related information may be configured to be most preferentially displayed.

The instructions may cause the processor to: acquire user information of an electronic device which provides the first source information, and adjust the access right to access the target display based on the user information.

The access right to access the target display may be adjusted based on the user information indicating that a corresponding user is a driver.

The access right to access the target display may be adjusted based on the user information indicating that a corresponding user is a non-driver.

The instructions may cause the processor to detect a connection with an electronic device which provides the first source information.

The instructions may cause the processor to adjust the access right to access the target display based on a connection position of the electronic device.

According to an embodiment, a method for controlling a display of a vehicle includes acquiring display configuration information related to multiple displays in a vehicle, identifying an access right to access a target display which is at least some of the multiple displays, based on the display configuration information, acquiring first source information, generating second source information to be displayed on the target display, from the first source information based on the access right, and controlling to transmit the second source information to the target display.

The display configuration information may include at least one piece of information among identification information of a display, and position information in the vehicle of the display.

The target display may correspond to one of a first display located at a driver seat or a second display located at a non-driver seat. A right to access the first display may be configured differently from a right to access the second display.

The method may further include acquiring unique vehicle information. The second source information may further include the unique vehicle information.

The method may further include configuring safety-related information so as to be most preferentially displayed, when the unique vehicle information includes the safety-related information.

The method may further include acquiring user information of an electronic device which provides the first source information. The access right to access the target display may be adjusted based on the user information.

The method may further include detecting a connection with an electronic device which provides the first source information, and adjusting the access right to access the target display based on a connection position of the electronic device.

According to an embodiment, a vehicle includes at least one display in the vehicle configured to be capable of displaying an image, and an electronic device configured to electrically control the vehicle. The electronic device may be configured to store display configuration information related to the at least one display in the vehicle, identify an access right to access a target display which is at least some of the at least one display, based on the display configuration information, acquire first source information, generate second source information to be displayed on the target display, from the first source information based on the access right, and transmit the second source information to the target display.

FIG. 17 illustrates a configuration of an electronic device 1701 in a network environment 1700 according to an embodiment.

FIG. 17 illustrates a configuration of the electronic device 1701 in the network environment 1700 according to an embodiment. Referring to FIG. 17, the electronic device 1701 in the network environment 1700 may communicate with an electronic device 1702 through, a first network 1798, such as a short-range wireless communication network, or may communicate with an electronic device 1704 or a server 1708 through a second network 1799, such as a long-range wireless communication network. The electronic device 1701 may communicate with the electronic device 1704 through the server 1708. The electronic device 1701 may include a processor 1720, a memory 1730, an input apparatus 1750, a sound output apparatus 1755, a display apparatus 1760, an audio module 1770, a sensor module 1776, an interface 1777, a haptic module 1779, a camera module 1780, a power management module 1788, a battery 1789, a communication module 1790, a subscriber identification module 1796, or an antenna module 1797. In some embodiments, at least one of the display apparatus 1760 or the camera module 1780 of the elements may be omitted from the electronic device 1701, or one or more other elements may be added thereto. In some embodiments, some of the elements may be implemented as a single integrated circuit. For example, the sensor module 1776, such as a fingerprint sensor, an iris sensor, or an illuminance sensor, may be implemented to be embedded in the display apparatus 1760.

For example, the processor 1720 may execute a program 1740 so as to control at least one hardware or software element other than the program 1740 of the electronic device 1701 connected to the processor 1720, and may perform various data processing operations or arithmetic operations. The processor 1720 may load, into a volatile memory 1732, commands or data received from another element, such as the sensor module 1776 or the communication module 1790, as at least some of the various data processing operations or arithmetic operations, may process commands or data stored in the volatile memory 1732, and may store resulting data in a non-volatile memory 1734. The processor 1720 may include: a main processor 1721, such as a central processing unit or an application processor, and an auxiliary processor 1723, such as a graphic processing apparatus, an image signal processor, a sensor hub processor, or a communication processor, which can operate independently of or together with the main processor 1721. Additionally or alternatively, the auxiliary processor 1723 may use power lower than that consumed by the main processor 1721, may be configured to be specialized for a designated function. The auxiliary processor 1723 may be implemented separately from the main processor 1721, or as a part of the main processor 1721.

The auxiliary processor 1723 may control at least some of functions or states associated with at least one element, such as the display apparatus 1760, the sensor module 1776, or the communication module 1790, among the elements of the electronic device 1701, on behalf of the main processor 1721 while the main processor 1721 is in an inactive, such as sleep state, or together with the main processor 1721 while the main processor 1721 is in an active state. The auxiliary processor 1723, such as an image signal processor or a communication processor, may be implemented as a part of another functionally-related element, such as the camera module 1780 or the communication module 1790.

The memory 1730 may store various data used by at least one element, such as the processor 1720 or the sensor module 1776 of the electronic device 1701. Data may include the program 1740, and input or output data for commands associated with the software. The memory 1730 may include a volatile memory 1732 or a non-volatile memory 1734.

The program 1740 may be stored, as software, in the memory 1730 and may include an operating system 1742, middleware 1744, or an application 1746.

The input apparatus 1750 may receive, from the outside (e.g., the user) of the electronic device 1701, commands or data to be used in an element, such as the processor 1720 of the electronic device 1701. The input apparatus 1750 may include a microphone, a mouse, a keyboard, or a digital pen, such as a stylus pen.

The sound output apparatus 1755 may output a sound signal to the outside of the electronic device 1701. The sound output apparatus 1755 may include a speaker or a receiver. The speaker may be used for general use such as multimedia reproduction or sound reproduction, and the receiver may be used only for reception of an incoming telephone call. The receiver may be implemented separately from the speaker, or as a part of the speaker.

The display apparatus 1760 may visually provide information to the user of the electronic device 1701. The display apparatus 1760 may include a display, a hologram apparatus, or a projector, and a control circuit configured to control the corresponding apparatus. The display device 1760 may include a touch circuit configured to detect a touch or a sensor circuit, such as a pressure sensor, configured to measure the amount of force generated by the touch.

The audio module 1770 may bidirectionally convert between a sound and an electrical signal. The audio module 1770 may acquire a sound through the input apparatus 1750 or may output a sound through the sound output apparatus 1755 or an external electronic device, such as the electronic device 1702, such as a speaker or headphone, connected to the electronic device 1701 in a wired or wireless manner.

The sensor module 1776 may detect an operating state, such as power or temperature of the electronic device 1701 or an external environmental state, such as a user's state, and may generate an electrical signal or a data value corresponding to the detected state. The sensor module 1776 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support at least one designated protocol which can be employed so that the electronic device 1701 is connected to an external electronic device 1702 in a wired or wireless manner. The interface 1777 may include a high definition multimedia interface (HDMI), a universal serial bus (USB) interface, a secure digital (SD) card interface, or an audio interface.

The connection terminal 1778 may include a connector through which the electronic device 1701 can be physically connected to an external electronic device 1702). The connection terminal 1778 may include an HDMI connector, a USB connector, an SD card connector, or a headphone connector.

The haptic module 1779 may convert an electrical signal into a mechanical stimulus, such as vibration or motion) or an electrical stimulus that the user can perceive through a tactile or kinesthetic sense. The haptic module 1779 may include a motor, a piezoelectric element, or an electrical stimulation apparatus.

The camera module 1780 may capture a still image and a moving image. The camera module 1780 may include at least one lens, an image sensor, an image signal processor, or a flash.

The power management module 1788 may manage the power supplied to the electronic device 1701. The power management module 1788 may be implemented as at least a part of a power management integrated circuit (PMIC).

The battery 1789 may supply power to at least one element of the electronic device 1701. The battery 1789 may include a non-rechargeable primary battery, a rechargeable secondary battery, or a fuel cell.

The communication module 1790 may establish a direct (e.g., wired) or wireless communication channel between the electronic device 1701 and an external electronic device, such as the electronic device 1702, the electronic device 1704, or the server 1708), and may support execution of communication through the established communication channel. The communication module 1790 may include the processor 1720, such as an application processor, and at least one communication processor which independently operates and supports direct (e.g., wired) communication or wireless communication. The communication module 1790 may include a wireless communication module 1792, such as a cellular communication module, a short-range wireless communication module, or a global navigation satellite system (GNSS) communication module or a wired communication module 1794, such as a local area network (LAN) communication module or a power line communication module). A corresponding communication module among the above-described communication modules may communicate with an external electronic device through a first network 1798, such as a short-range communication network, such as Bluetooth®, Wi-Fi direct, or Infrared Data Association (IrDA) or a second network 1799, such as a long-range communication network, such as a cellular network, the Internet, or a computer network, such as a LAN or a WAN). Various types of communication modules described above may be integrated into one element, such as a single chip, or may be implemented as multiple separate elements, such as multiple chips. The wireless communication module 1792 may identify and authenticate the electronic device 1701 in a communication network, such as the first network 1798 or the second network 1799, by using subscriber information, such as an international mobile subscriber identity (IMSI) module stored in the subscriber identification module (SIM) card 1796.

The antenna module 1797 may transmit or receive signals or power to/from an external electronic device. The antenna module 1797 may include one antenna including a radiator made of a conductor or a conductive pattern formed on a substrate, such as a PCB. The antenna module 1797 may include multiple antennas. In this example, at least one antenna suitable for a communication scheme employed in a communication network, such as the first network 1798 or the second network 1799, may be selected from the multiple antennas by the communication module 1790. The communication module 1790 may transmit or receive signals or power to/from an external electronic device through the selected at least one antenna. According to some embodiments, another component, such as a radio-frequency integrated circuit (RFIC) may be additionally configured as a part of the antenna module 1797, as well as a radiator.

At least some of the above-described elements may be connected to each other via a communication scheme between neighboring devices, such as a bus, a general-purpose input/output (GPIO) scheme, a serial peripheral interface (SPI), or a mobile industry processor interface (MIPI), and may mutually exchange signals, such as commands or data therebetween.

The electronic device 1701 may transmit or receive commands or data to/from the external electronic device 1704 through the server 1708 connected to the second network 1799. Each of the electronic devices 1702 and 1704 may be of a type which is the same as, or different from, that of the electronic device 1701. All or some of the operations executed by the electronic device 1701 may be executed by at least one external electronic device among the external electronic devices 1702, 1704, and 1708. For example, when the electronic device 1701 should perform some functions or services automatically or in response to a request of a user or another device, the electronic device 1701 may request at least one external electronic device to perform at least some of the functions or services, instead of, or in addition to, performing the functions or services by itself. The at least one external electronic device having received the request may execute at least some of the requested functions or services or additional functions or services related to the requek, and may deliver a result of the execution to the electronic device 1701. The electronic device 1701 may process the result as it is or additionally, and thus, may provide the processed result as at least a part of a response to the request. To this end cloud-computing, distributed-computing, or client-server-computing technology may be used.

An electronic device according to embodiments disclosed herein may be any of various types of devices. The electronic device may include a portable communication device, a computer device, a portable multimedia device, a portable medical device, a camera, a wearable device, or a home appliance. The electronic device according to the embodiments is not limited to the above-described devices.

The various embodiments disclosed herein may be implemented in software (e.g., the program 1740) including at least one instruction stored in a storage medium (e.g., an internal memory 1736 or an external memory 1738) readable by a machine (e.g., the electronic device 1701). For example, a processor (e.g., the processor 1720) of a device (e.g., the electronic device 1701) may call and execute at least one instruction among the one or more stored instructions from the storage medium. This configuration allows the device to be operated to perform at least one function according to the called at least one instruction. The one or more instructions may include a code generated by a compiler or a code executable by an interpreter. The machine-readable storage medium may be provided in the form of a non-transitory storage medium. Here, the term “non-transitory” only means that the storage medium is a tangible device and does not include a signal (e.g., an electromagnetic wave) and does not distinguish between a case in which data is semi-permanently stored in the storage medium and a case in which the data is temporarily stored in the storage medium.

According to an embodiment, the method according to embodiments disclosed herein may be included and provided in a computer program product. The computer program product may be traded as a product between a seller and a buyer. The computer program product may be distributed in the form of a machine-readable storage medium, such as a compact disc read only memory (CD-ROM), or may be distributed (e.g., downloaded or uploaded) online via an application store (e.g., Play Store™), or directly between two user devices (e.g., smart phones). If distributed online, at least a part of the computer program product may be temporarily generated or at least temporarily stored in the machine-readable storage medium, such as a memory of the manufacturer's server, a server of the application store, or a relay server.

According to various embodiments, each (e.g., a module or a program) of the above-described elements may include a single entity or multiple entities. One or more elements among the above-described elements or operations may be omitted, or one or more other elements or operations may be added. Alternatively or additionally, multiple modules or programs may be integrated into a single element. In this configuration, the integrated element may still perform the functions performed by each of the corresponding elements in a manner the same as or similar to that before the corresponding elements are integrated. Operations performed by a module, a program, or other elements may be executed sequentially, in parallel, repeatedly, or in a heuristic manner, or one or more of the operations may be executed in another order, may be omitted, or may further include one or more other operations.

While the disclosure has been shown and described with reference to embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
a memory; and
a processor configured to be operatively connected to the communication circuit and the memory,
wherein the memory stores instructions that, when executed, cause the processor to:
acquire display configuration information related to multiple displays in a vehicle;
identify an access right to access a target display which is at least two of the multiple displays, based on the display configuration information;
acquire first source information;
generate second source information to be displayed on the target display, from the first source information, based on the access right; and
transmit the second source information to the target display through the communication circuit.

2. The electronic device of claim 1, wherein the display configuration information comprises at least one piece of information among:
identification information of the target display; and
position information in the vehicle of the target display.

3. The electronic device of claim 2, wherein the display configuration information further comprises at least one of:
whether to allow access to the target display;
an allowable range of access to the target display;
information on a vehicle network environment; and
a device profile of the electronic device related to the target display.

4. The electronic device of claim 1,
wherein the target display corresponds to one of a first display located at a driver seat and a second display located at a passenger seat, and
wherein a right to access the first display is configured differently from a right to access the second display.

5. The electronic device of claim 1, wherein the second source information comprises at least one piece of information among:
information corresponding to at least a part of the first source information;
information distributed from the first source information;
information extracted from the first source information;
information resulting from processing of the first source information;
information which shares the at least the part of the first source information; and
information obtained by customizing the at least the part of the first source information so as to correspond to the target display.

6. The electronic device of claim 1, wherein the second source information further comprises unique vehicle information.

7. The electronic device of claim 6, wherein, when the unique vehicle information comprises safety-related information, the safety-related information is configured to be preferentially displayed.

8. The electronic device of claim 1, wherein the instructions further cause the processor to:
acquire user information of an electronic device which provides the first source information; and
adjust the access right to access the target display based on the user information.

9. The electronic device of claim 8, wherein the access right to access the target display is adjusted based on the user information indicating that a corresponding user is a driver.

10. The electronic device of claim 8, wherein the access right to access the target display is adjusted based on the user information indicating that a corresponding user is a passenger.

11. The electronic device of claim 1, wherein the instructions further cause the processor to detect a connection with an electronic device which provides the first source information.

12. The electronic device of claim 1, wherein the instructions further cause the processor to adjust the access right to access the target display based on a connection position of the electronic device.

13. A method for controlling a display of a vehicle, the method comprising:
acquiring display configuration information related to multiple displays in a vehicle;
identifying an access right to access a target display which is at least two of the multiple displays, based on the display configuration information;
acquiring first source information;
generating second source information to be displayed on the target display, from the first source information based on the access right; and
controlling to transmit the second source information to the target display.

14. The method of claim 13, wherein the display configuration information comprises at least one piece of information among:
identification information of the target display; and
position information in the vehicle of the target display

15. The method of claim 13,
wherein the target display corresponds to one of a first display located at a driver seat or a second display located at a passenger seat, and
wherein a right to access the first display is configured differently from a right to access the second display.

16. The method of claim 13, further comprising acquiring unique vehicle information,
wherein the second source information further comprises the unique vehicle information.

17. The method of claim 16, further comprising, when the unique vehicle information comprises safety-related information, configuring the safety-related information so as to be preferentially displayed.

18. The method of claim 13, further comprising acquiring user information of an electronic device which provides the first source information,
wherein the access right to access the target display is adjusted based on the user information.

19. The method of claim 13, further comprising:
detecting a connection with an electronic device which provides the first source information; and
adjusting the access right to access the target display based on a connection position of the electronic device.

20. A vehicle comprising:
at least one display in the vehicle configured to be capable of displaying an image; and
an electronic device configured to electrically control the vehicle,
wherein the electronic device is configured to:
store display configuration information related to the at least one display in the vehicle;
identify an access right to access a target display which is at least some of the at least one display, based on the display configuration information;
acquire first source information;
generate second source information to be displayed on the target display, from the first source information based on the access right; and
transmit the second source information to the target display.
